(19) United States
(12) Patent Application Publication
(10) Pub. No.: US 2019/0034580 A1
(43) Pub. Date: Jan. 31, 2019

(54) METHODS FOR IMPROVED ARRAYS OR LIBRARIES USING NORMALIZATION STRATEGIES BASED ON MOLECULAR STRUCTURE

(71) Applicant: Arizona Board of Regents on behalf of Arizona State University, Scottsdale, AZ (US)

(72) Inventor: Neal Woodbury, Tempe, AZ (US)

(21) Appl. No.: 16/043,780

(22) Filed: Jul. 24, 2018

Related U.S. Application Data
(60) Provisional application No. 62/537,810, filed on Jul. 27, 2017.

(51) Int. Cl. G06F 19/12; G06F 19/24

(52) U.S. Cl. CPC G06F 19/12; G06F 19/24

(57) ABSTRACT

Methods of analyzing and normalizing data from a peptide array or library including a set of chemical structures using a model. Some embodiments involve obtaining a data set associated with a specific set of structures based on a signal (e.g., fluorescence) derived from interaction (e.g., binding) of the set of structures with an added molecule of interest. For example, a compositional model is then applied to the data set to normalize and thereby remove at least a portion of the signal due to composition alone. Information derived from the data can be used to predict the composition, sequence, charge, hydrophobicity and chemical properties of chemical structures (e.g., peptides) to be used on a molecular array or other substrate.

### CROSS-REFERENCE TO RELATED APPLICATION

This application claims the benefit of and priority to U.S. Provisional Patent Application No. 62/537,810, filed on Jul. 27, 2017, the disclosure of which is incorporated herein in its entirety.

### STATEMENT AS TO FEDERALLY SPONSORED RESEARCH

This invention was made with the support of the United States government under Contract number 1243082 by the National Science Foundation. The government has certain rights in the invention.

### BACKGROUND OF THE INVENTION

Molecular arrays are useful tools for diagnosing various types of diseases. The manufacture of molecular arrays can be sensitive to a large number of distinct parameters, including the nature of biochemical molecules present in the array. An efficient way to characterize the chemical structures of arrays (or libraries of molecules, molecules on beads or other substrates) in terms of their binding properties is useful in optimizing array performance and manufacturing yield of molecular arrays that consistently have high quality. In particular, one is often interested in structurally specific molecular recognition, which depends on the precise structure of the molecules in the library, as opposed to just their general properties such as charge, hydrophobicity, aromaticity, etc. It would thus be useful to be able to characterize the binding properties of the arrays in such a way that the structurally specific interactions could be separated from the interactions that depend on general properties.

### SUMMARY OF THE INVENTION

Methods of analyzing and normalizing data from a peptide array or library including a set of chemical structures using models that separate binding due to specific structural interaction as opposed to binding based on properties of the molecule that do not give rise to structure-specific interactions.

In some embodiments, the methods involve obtaining a data set associated with a specific set of structures based on a signal (e.g., fluorescence) derived from interaction (e.g., binding) of the set of structures with an added molecule or molecules of interest. A model is then applied to the data which separates the structurally specific binding interactions from the less specific binding based on general physical properties of the molecule. This less specific binding can then be at least partially removed by normalization or subtraction based on the model.

Removing this less specific binding from the dataset by normalization or subtraction often results in the ability to make more accurate conclusions based on the structurally specific binding. Such approaches can be used, for example, to enhance the ability to discriminate between serum samples from patient populations with and without a disease, where one would expect structurally specific interactions to be most informative and more general chemical interactions to provide a background of unwanted noise.

Thus, in some embodiments, methods are disclosed for analyzing data from an array or library comprising a set of chemical structures, with an exemplary method including (1) obtaining a data set associated with the set of structures based on a signal derived from interaction of the set of structures with an added molecule or molecules of interest; and (2) applying a model description to the data set that enables the removal at least a portion of the signal due to chemical composition rather than covalent structure.

In other embodiments, the method may further include the step of evaluating the effect of removing at least a portion of the signal on the ability to classify an interaction between the set of structures and a test sample (for example, to help better discriminate a disease from control and/or healthy samples).

In further embodiments, the method may utilize the model:

$${F}_{i} = {\sum }_{I} {a}_{y} {C}_{i , j} ,$$

wherein Fi is fluorescence from chemical structure i, aj is a coefficient determined in the fit for the j types of chemical structure subunits, and Ci,j is the composition in terms of the number of each of the j chemical structure subunits in chemical structure i. The chemical subunits may include but are not limited to amino acids, nucleic acids, monomer subunits of polymers, and the like. Moreover, the molecule or molecules of interest may include but are not limited to antibodies, proteins, peptides, nucleic acids, and the like.

In certain embodiments, the signal comprises imaging of the interaction between the set of structures and the added molecule or molecules of interest (for example, through a florescent marker associated with the molecule or molecules of interest).

In certain embodiments, the steps of applying and/or evaluating is performed with a specially programmed digital processing device that includes one or more non-transitory computer readable storage media encoded with one or more programs that processes information as described.

These and other aspects will be further described in the drawings and disclosure below. However, the scope of the claims is not intended to be limited to the embodiments and examples herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings in the following.

FIG. 1 shows a Pearson Correlation Coefficient as a function of how many of the N-terminal amino acids were used in the compositional fit.

FIG. 2 illustrates the classification accuracy with the x-axis being the same as in FIG. 1.

FIG. 3 shows the distributions for the data before and after normalization with the fit.

### DETAILED DESCRIPTION OF THE INVENTION

Disclosed herein are methods, systems and devices for developing and optimizing array features for detection and analysis of binding molecules in a complex biological sample (for example, antibodies) to targets on an array (for example, peptides).

Immunotherapy and antibody-based treatment of cancer have been two major therapeutic breakthroughs in extending patient survival. Immunotherapy activates and utilizes the patient's immune system to kill cancer cells, whereas antibody-based therapeutics target specific pathways that inhibit or kill cancer cells. Each of these approaches rely heavily or exclusively on the discovery and development of highly target-specific antibodies or biologics and more recently, multi target-specific antibodies or biologics with multivalent binding. Even with the significant advancement in patient survival offered by immunotherapy and antibody-based treatment, specific major challenges remain.

Synthesized peptide libraries are commonly used for antibody binding characterization, but this is expensive and limited to a small sample of sequence space (i.e., epitope mapping/binning). Antibody characterization with synthesized peptide libraries is currently performed with relatively low-throughput methods such as surface plasmon resonance and interferometry. Protein and peptide microarrays can be used to characterize greater than 10,000 antibody-peptide interactions, but protein and robotically printed peptide arrays have been cost-prohibitive and in situ synthesized peptide arrays can suffer from lack of scalability, reproducibility and production quality. However, the ability to both design the composition of the arrays to meet specified applications and the ability to use the information gained from the arrays to make predictions about interactions not directly on the array should help address or overcome past issues with protein and peptide arrays.

Some embodiments disclosed herein are based on computer simulation for selecting chemical structures on peptide array construction. The simulation results enable reliable, high-throughput, low-cost and comprehensive binding characterization of therapeutic antibody and biologic lead candidates. For example, benefits of the technologies include: 1) Designing a better process for array manufacturing; 2) Improving array features for disease binding; 3) Lowering array costs; and predicting new binding interactions; 4) distinguishing structurally-specific interactions from interactions that do not provide structurally specific information.

### Peptide Arrays

The technologies disclosed herein are described in terms of the binding of antibodies in blood to peptides on an array. In principle, however, it is equally applicable to other situations in which there are a set of fixed chemical structures interacting with a complex mixture and some measurement is then made from each of the fixed chemical structures or a subset of those structures.

In some embodiments, the complex biological sample may comprise blood, serum, plasma, lymph fluid, interstitial fluid, amniotic fluid, sweat, tears, peritoneal fluid, sebum, cerebral spinal fluid, urine, saliva, feces, synovial fluid, pus, nasal drainage or phlegm, pleural fluid, waste water, effluent or other complex fluidic sample.

In various embodiments, the technologies disclosed herein analyze, include or use circulating antibodies in blood or a bodily fluid, including immunoglobulins such as immunoglobulin G (i.e., IgG class). There are on the order of 10⁹ different IgG molecules in blood, most of which are present at very low concentrations in a blood sample. The total concentration of IgG in blood is on the order of 10 mg/ml or about 70 micromolar. Antibodies are present in a huge diversity of concentrations. For example, a relatively small number of antibodies (10-100) can make up a few percent of the total IgG during an active infection.

In various embodiments, the technologies disclosed herein include a peptide array. In some embodiments, a peptide array comprises a fixed area, for instance 0.2 cm², 0.3 cm², 0.4 cm², 0.5 cm², 0.6 cm², 0.7 cm², 0.8 cm², 0.9 cm², 1.0 cm², preferably 0.5 cm². In some embodiments, a peptide array comprises molecules arranged as features in a regular array with at least 20%, at least 30%, at least 40%, at least 50%, at least 60%, at least 70%, at least 80% or at least 90% of the area covered by the peptide features and at least 10%, at least 20%, at least 30%, at least 40%, at least 50%, at least 60%, at least 70% or at least 80% by interstitial space.

In some embodiments, a density (e.g., the number of individual peptides per square nanometer) is a variable in the analysis. In some embodiments, the density of the peptides is centered at 0.1, 0.2, 0.3, 0.4, 0.5, 0.6, 0.7, 0.8, 0.9, 1.0, 1.2, 1.5, 1.8, 2, 2.5, 3.0, 3.5, 4.0, 4.5, 5.0, 5.5 or 6.0 nanometers. In yet other embodiments, the distance between peptides is not more than 0.5 nanometers, not more than 1.0 nanometer, not more than 1.5 nanometers, not more than 2 nanometers, not more than 2.5 nanometers, not more than 3 nanometers, not more than 3.5 nanometers, not more than 4 nanometers, not more than 4.5 nanometers, not more than 5 nanometers, not more than 5.5 nanometers, not more than 6 nanometers, preferably not more than 0.5 nanometers, 1.0 nanometer or 1.5 nanometers. In a peptide array, the peptides are assumed to be arranged generally randomly such that the Kd values with respect to particular Abs (see below) have a generally continuous distribution. In other embodiments, the peptide arrays may contain pseudo- random peptides arranged such that the Kd values with respect to particular Abs (see below) have a generally continuous distribution. In yet other embodiments, the peptide sequences in the peptide arrays may be pre-derived.

In some embodiments, it is assumed that all peptide features contain the same number of peptides and thus the same number of Ab binding sites. In some embodiments, the number of moles of each peptide on the surface depends on the size of the features. In some examples, the number of moles of each peptide on the surface may be approximately 5×10⁻¹⁶, or a total of 5×10⁻¹¹ moles of total peptide.

### Incubation Chamber and Assay Process

In various embodiments, the technologies disclosed herein include an incubation chamber for an array processing. The volume of the chamber over the peptides is considered a variable, but is preferably at 150 microliters. In yet other embodiments, the volume of the chamber is 50 microliters, 60 microliters, 70 microliters, 80 microliters, 90 microliters, 100 microliters, 110 microliters, 120 microliters, 130 microliters, 140 microliters, 150 microliters, 160 microliters, 170 microliters, 180 microliters, 190 microliters, 200 microliters, 210 microliters, 220 microliters, 230 microliters, 240 microliters, 250 microliters, 300 microliters, 325 microliters, 350 microliters, 375 microliters, 400 microliters, 425 microliters, 450 microliters, 475 microliters,500 microliters, 900 microliters, or more. Alternatively, a flow cell may be used in washing.

In some embodiments, a binding simulation is performed assuming a constant temperature. In other embodiments, the temperature of the assay varies throughout the course of the assay. In yet other embodiments, the temperature of the assay is ambient temperature. In some embodiments, washes are either done in infinite volume or a fixed volume, also centered at 150 microliters, which is described as a variable in a simulation model. In yet other embodiments, wash volumes include 100 microliters, 150 microliters, 200 microliters, 250 microliters, 300 microliters, 350 microliters, 400 microliters, 450 microliters, or 500 microliters.

In some embodiments, the dilution of the blood applied to an array is a variable. In some embodiments, the blood sample is diluted by 1×, by 2×, by 3×, by 4×, by 5×, by 6×, by 7×, by 8×, by 9×, by 10×, by 20×, by 30×, by 40×, by 50×, by 60×, by 70×, by 80×, by 90×, by 100×, by 150×, by 200×, by 300×, by 400×, by 500×, by 600×, by 700×, by 800×, by 900×, by 1000×, by 1100×, by 1200×, by 1300×, by 1400×, by 1500×, by 1600×, by 1700×, by 1800×, by 1900×, by 2000×, by 2500×, by 3000×, by 3500×, by 4000×, by 4500×, by 5000×, by 5500×, by 6000×, by 6500×, by 7000×, by 7500×, by 8000×, by 8500×, by 9000×, by 9500×, by 10,000×, by 20,000×, by 30,000×, by 40,000×, by 50,000×, by 60,000×, by 70,000×, by 80,000×, by 90,000×, by 100,000×, by 200,000×, by 300,000×, by 400,000×, by 500,000×, by 600,000×, by 700,000×, by 800,000×, by 900,000 or by 1,000,000×. Preferably, the blood is diluted by 660×, giving a final IgG concentration of about 70 nM.

In some embodiments, an effective peptide concentration in 150 microliters (total peptide) is about 250 nM. Thus for the studies the peptide is generally in excess. In general, as discussed below, only about 1% of the peptides on average are bound to Ab; of course in various embodiments, some peptides are much more and some much less.

In some embodiments, the binding time of the assay is variable. In some embodiments, the binding time is 10 minutes, 20 minutes, 30 minutes, 40 minutes, 50 minutes, 60 minutes, 1 hour, 2 hours, 3 hours, 4 hours, 5 hours, 6 hours, 7 hours or more. Preferably, binding time of the assay centered at 1 hour and varied. In other embodiments, the wash time of the assay varied from 1 minute, 2 minutes, 5 minutes, 7 minutes, 10 minutes, 15 minutes, 20 minutes, 25 minutes, 30 minutes, 45 minutes, 1 hour or more. Usually the wash was considered to be against an infinite dilution and performed for 15 minutes (also varied) though small volume washes and longer times were also considered.

### Array/Library Normalization

In some embodiments, provided herein are methods, systems and devices for array or library normalization strategies with regard to particular molecular structures and specific signals. Consider for example, a series of molecular structures. These structures could be organized on a surface, such as in an array, or on beads, or could be in another format where each type of structure or groups of related structures can be assayed resulting in a set of values. The molecules could be of any composition, so long as there is a particular structure or somehow related family of structures associated with each measurement. In some embodiments, the assay or measurement involves binding to a chemical or mixture of chemicals or complex fluidic samples. In yet other embodiments, the assay or measurement involves chemical reactivity, for example, chemical reactions that are structurally dependent, such as covalent modification, catalysis or other structural modifications. Fundamentally, any signal that derives specifically from the interaction of a specific molecular structure with the material added will result in a set of values associated with a set of structures.

In some embodiments, the binding reaction to the array structures can be detected in any of a number of ways. In one embodiment, a labeled ligand is used to detect antibodies binding to peptides on an array surface. In other embodiments, a secondary antibody that binds to all of the antibodies (or a specified subset, such as all IgG) present is used to detect antibodies binding peptides on an array surface. In yet other embodiments, the signals can be read from the intensity of the label (e.g., a fluorescence label read by an array reader that is commercially available). In still other embodiments, analysis of the relationship between the properties of the structures and the level of the signal is determined.

In some embodiments disclosed herein are arrays of peptides that bind to antibodies in a sample, for example blood, in a manner that depends on at least some aspect of the peptide array structure or structural characteristics. Linear peptides, for example, consist of a set of amino acids linked together in a particular order.

In this case, one might relate the binding of the antibody in the fluid sample to various aspects of the structure such as

Fᵢ=Sᵢ*Σⱼaⱼc_{i,j} (1)

Here the signal of the i^{th} peptide is F₁, the composition of the i^{th} peptide is given by the j values, C_{i,j} and each of those j composition values is modified by a coefficient aⱼ. The sum shown above represents the part of the signal that can be described by the composition of the peptide without regard to order of the amino acids of the peptide. Sᵢ represents the part of the signal that is due to the sequence (order) of amino acids beyond what is determined simply from the composition of amino acids. In some embodiments, the functional form shown here is only one of a number of possible functional forms.

In other embodiments, another possibility for relating the binding of the antibody in the fluid sample to various aspects of a structure is

Fᵢ=Sᵢ+Σⱼaⱼc_{i,j} (2)

Either functional form, as well as a number of others, could be used to describe the system equally well, but the nature of the modifier Sᵢ changes depending on the form of the above equation (1) or (2). The log of the fluorescence is used when the relationships considered are likely to be linear functions of the free energies of a set of interactions.

In some embodiments, analysis is narrowed to only that part of the signal that is dependent on the order of amino acids. In these embodiments, specific antibody binding is thought to be highly sequence dependent rather than just composition dependent. In either formulation, this might be done by first fitting the signal to the composition using a linear fit of Fᵢ to the coefficients aᵢ in the expression

fᵢ=Σⱼaⱼc_{i,j} (3)

Where fᵢ are the calculated values and an expression such as

Σⱼ(Fᵢ−fᵢ)² (4)

is minimized and then the values of fᵢ derived are used to modify the measured values F₁ in such a way as to remove the influence of composition from the signal.

For example, if equation (1) is used to describe the array, one might normalize the array such that each measurement Fᵢ in the array is replaced by Fᵢ/fᵢ or if equation (2) is used, Fᵢ could be replaced by Fᵢ−fᵢ. Other formulations of the relationship between the compositionally dependent part of the signal and the remaining part of the signal depending on order would result in different approaches to removing the compositional part by some form of normalization.

In some embodiments, fitting is an approach used for normalization of the analysis. In yet other embodiments, the average or the median of the signal from all peptides that have the same composition is taken and then divided amongst all peptide measurements by that average or median. This would not involve fitting, but would be another form of normalizing the values to remove the part of the signal due to composition alone and leave signal that was due to the order of the amino acid. In still other embodiments, the opposite could be done by the approaches above; one could remove the part of the signal due to order and only consider that part that is describable based on composition.

Those skilled in the art will realize that there are many different ways to characterize a chemical structure. For example, instead of considering the measurement as a function of the order and the composition, one might consider the measurement in terms of the part of the value that depends on the charge and the part that does not. Alternatively, hydrophobicity, length (number of amino acids in the case of a peptide), molecular weight, solubility, or calculated properties of the structure such as volume, flexibility, and many other chemical and structural properties of the molecules in the array or library could be used in a similar fashion. There is a substantial literature on the subject of chemical descriptors used for different kinds of molecular structures. For example, one list of descriptors used to describe peptides is given by Sanberg et al., 1998, J. Med. Chem. 41, 2481-2491. Some descriptors used in other small molecule libraries are discussed and reviewed by Gozalbes and Pineda-Lucena, Comb. Chem. High Throughput Screen., 2011, 14, 548-458. One descriptor could be used or combinations of descriptors could be used by, e.g., adding additional sum terms over various descriptors to equations (1) or (2). As noted above, one could selectively remove one part or another of the signal, as appropriate for the application.

### Composition as a Function of Position

In some embodiments, provided herein are methods, systems and devices including composition as a function of position. Referring to FIG. 5, consider peptides that are 4 amino acids long made of only 4 amino acids: “N,” “E,” “A,” and “L.” Given a set of peptides in configurations 701, 702 and 703, and fitting a matrix of coefficients 704, binding values can derived by the sum of each term in a particular peptide matrix times each term in the coefficient matrix. The biding values are: AEEL 1.17, LNEA 0.44, and ENNA 0.24.

In some embodiments, for an array that uses 16 amino acids and a model that considers compositions in 7 positions, the number of coefficients per position and the total number of coefficients are summarized in Table 1.

TABLE 1

| | # of coefs. per position | Total # coefs. |
|---|---|---|
| 1-mers | 16 | 112 |
| 2-mers | 256 | 1792 |
| 3-mers | 4096 | 28672 |

The evaluation in Table 1 is based on simple, linear models fitting to the log of the fluorescence (free energies add and are like logs of concentrations), provides a useful starting point for the algorithm described herein. The fit to 1-mers (individual amino acids at particular positions) assumes that each individual amino acid contributes to the binding independently at a particular position. This is structurally more specific than models described above that depend only on overall amino acid composition, but still does not capture nonlinear, inter-amino acid interactions that are likely important in most specific binding interactions. The fit to 2-mers (consecutive pairs of amino acids) partially compensates for this lack of interaction by considering ordered pairs of amino acids in the structure rather than individual amino acids. The fit the 3-mers (consecutive sets of three amino acids) adds yet more structurally-specific information to the description. As one increases the number of amino acids in the structural unit, the number of possible sets of structural units increases exponentially, as shown in table 1.

In some embodiments, the technologies involve the following process: (a) A study randomly splits peptides of an array in half (e.g., 50% training peptides and 50% testing peptides), and (b) randomly splits the samples into two parts (e.g., 75% training samples and 25% testing samples, where the percentages are adjusted based on studies). Then, the process (c) fits all samples on the training peptides (this becomes the reduced training set), and (d) fits all samples on the test peptides (this becomes the reduced test set). The process then (e) selects the best coefficients to use in classification from the training samples run on the training peptides, and (f) generates a classifier using the best coefficients from the training samples on the training peptides. Finally, the process (g) applies the classifier to the coefficients from the test samples on the training peptides, and (h) applies the classifier to the coefficients from the test samples on the test peptides. The steps (b) to (h) are repeated the four-fold cross validation 10,000 times.

One benefit of the methods and technologies disclosed herein is to define array sequences. For instance, an array can be redesigned by the following process. The first step starts with a random array of hundreds of thousands to millions of features and a large sample set of a group of diseases that a user wishes to separate with the designed array. The second step is to fit samples to the predictive models. The third step uses the model to design a set of peptides that more easily distinguishes the diseases in question and evaluates the following: (a) design of a peptide set per array of about ˜20,000 in number (such that many more arrays can be manufactured per wafer, lowering production costs) (b) Use of about 10 of the amino acids and excluding the synthetically challenging ones. (c) Evaluation of the array for low and even background binding (d) Evaluation of whether all peptides sit comfortably in the dynamic range of binding (e) Evaluation of a set of samples that can be used to normalize the whole distribution.

A specific embodiment of studying the hepatitis B (HBV) vs. hepatitis C (HCV) panel is described as follows. The study includes samples comprising 44 HBV and 44 HCV seropositive donors. Samples were obtained from a commercial blood bank along with the signal over cutoff (SC/O) values for HBV and HCV immunoassays. An array comprised about ˜130,000 peptides on the array surface. Individual samples were diluted 1:1 with ethylene glycol as a cryo-protectant and aliquoted upon receipt and stored at −20° C. until needed. Selected samples were diluted in assay incubation buffer to 1:100 and aliquoted as single use volumes in a 96 well plate. Samples were arrayed such that each of the four slides assayed would have 11 HBV and 11 HCV donors. Plates were stored at −80° C. until needed. On the day of assay the single use plates are thawed on ice and samples further diluted 1:625 in assay buffer and applied to the array. Bound serum IgG is detected using an IgG specific secondary antibody that is labeled with a fluorophore. Automatic liquid handling systems are used for all sample dilution, reagent application and slide washing steps. Following the final wash and drying of the slides, slide images are obtained using a microarray scanner. Images are gridded using a gene array list file and tabulated data stored as a tab delimited text file. Table 2 shows the results of this study. The classification accuracy is based on the area under the receiver-operator curve (ROC). The left data column (Data from fit) shows the ability of the prediction from the fit to represent the difference between the two sets of samples. The first value (0.78) is the area under the ROC when all the data is used. When data is used from a representation that considers only individual amino acids (1-mer fit), the area under the ROC is much smaller than the original. As more structurally specific interactions are added (2-mers and 3-mers), the ability to reproduce the original information in the data improves. Thus, one can use these kinds of analyses to separate the less informative from the more informative data.

TABLE 2

| | AUC | |
|---|---|---|
| Dataset | Data from fit | Original minus fit |
| Full med norm dataset | 0.78 | |
| Recalculated data from 1-mer fit | 0.63 | 0.73 |
| Recalculated data from 2-mer fit | 0.73 | 0.74 |
| Recalculated data from 3-mer fit | 0.75 | 0.75 |

### Digital Processing Device

In some embodiments, the systems, platforms, software, networks, and methods described herein include a digital processing device, or use of the same. In further embodiments, the digital processing device includes one or more hardware central processing units (CPUs), i.e., processors that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, a digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetB SD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google° Android®, Microsoft® Windows Phone® OS, Microsoft® Windows Mobile® OS, Linux®, and Palm® WebOS®.

In some embodiments, a digital processing device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, a digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, a digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, a digital processing device includes a digital camera. In some embodiments, a digital camera captures digital images. In some embodiments, the digital camera is an autofocus camera. In some embodiments, a digital camera is a charge-coupled device (CCD) camera. In further embodiments, a digital camera is a CCD video camera. In other embodiments, a digital camera is a complementary metal-oxide-semiconductor (CMOS) camera. In some embodiments, a digital camera captures still images. In other embodiments, a digital camera captures video images. In various embodiments, suitable digital cameras include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, and higher megapixel cameras, including increments therein. In some embodiments, a digital camera is a standard definition camera. In other embodiments, a digital camera is an HD video camera. In further embodiments, an HD video camera captures images with at least about 1280×about 720 pixels or at least about 1920×about 1080 pixels. In some embodiments, a digital camera captures color digital images. In other embodiments, a digital camera captures grayscale digital images. In various embodiments, digital images are stored in any suitable digital image format. Suitable digital image formats include, by way of non-limiting examples, Joint Photographic Experts Group (JPEG), JPEG 2000, Exchangeable image file format (Exif), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), and WebP. In various embodiments, digital images are stored in any suitable digital video format. Suitable digital video formats include, by way of non-limiting examples, AVI, MPEG, Apple® QuickTime®, MP4, AVCHD®, Windows Media®, DivX™, Flash Video, Ogg Theora, WebM, and RealMedia.

### Non-Transitory Computer Readable Storage Medium

In some embodiments, the systems, platforms, software, networks, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, platforms, software, networks, and methods disclosed herein include at least one computer program. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server- side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. A web application for providing a career development network for artists that allows artists to upload information and media files, in some embodiments, includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

The systems, platforms, software, networks, and methods disclosed herein include, in various embodiments, software, server, and database modules. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### EXAMPLES

Consider a series of molecular structures. These structures could be organized on a surface, such as in an array, or on beads, or could be in another format (in a broad sense, a “library”) where each type of structure or groups of related structures can be assayed resulting in a set of values. The molecules could be of any composition, so long as there is a particular structure or a somehow related family of structures associated with each measurement. The assay or measurement could involve binding to a chemical or mixture of chemicals such as blood, serum, plasma, urine, saliva, waste water, effluent, etc. or it could involve chemical reactivity that was structurally dependent such as covalent modification, catalysis, etc. Fundamentally, any signal that derives specifically from the interaction of a specific molecular structure with the material added will result in a set of values associated with a set of structures.

As an example, consider an array of peptides that bind to the antibodies in blood in a manner that depends on some aspect of their structure. Linear peptides consist of a set of amino acids linked together in a particular order. The binding of the antibodies to the array can be detected in any of a number of ways, one possibility being the use of a labeled ligand, such as a secondary antibody, that binds to all of the antibodies (or a specified subset, such as all IgG) present. The signals can be read from the intensity of the label (e.g., a fluorescence label read by an array reader that is commercially available). One can then ask, is there some relationship between the properties of the structures and the level of the signal?

In this case, one might relate the binding to various aspects of the structure such as

Fᵢ=Sᵢ*Σⱼaⱼc_{i,j} (1)

Here the signal of the i^{th} peptide is Fᵢ, the composition of the i^{th} peptide is given by the j values, C_{i,j} and each of those j composition values is modified by a coefficient aⱼ. The sum shown above represents the part of the signal that can be described by the composition of the peptide without regard to order. Sᵢ represents the part of the signal that is due to the sequence (order) of amino acids beyond what is determined simply from the composition of amino acids. Note that the functional form shown here is only one of a number of possible functional forms. Another possibility is

i Fᵢ=Sᵢ+Σⱼaⱼc_{i,j} (2)

Either functional form, as well as a number of others, could be used to describe the system equally well, but the nature of the modifier Sᵢ changes depending on how the form is written.

One might, for example, be interested in only that part of the signal that is dependent on the order of amino acids as specific antibody binding is thought to be highly sequence dependent rather than just composition dependent. In either formulation, this might be done by first fitting the signal to the composition using a linear fit of Fᵢ to the coefficients aᵢ in the expression

fᵢ=Σⱼaⱼc_{i,j} (3)

Where fᵢ are the calculated values and an expression such as

Σⱼ(Fᵢ−fᵢ)² (4)

is minimized and then the values of fᵢ derived are used to modify the measured values Fᵢ in such a way as to remove the influence of composition from the signal. For example, if equation (1) is used to describe the array, one might normalize the array such that each measurement Fᵢ in the array is replaced by Fᵢ/fᵢ or if equation (2) is used, Fᵢ could be replaced by Fᵢ−fᵢ. Other formulations of the relationship between the compositionally dependent part of the signal and the remaining part of the signal depending on order would result in different approaches to removing the compositional part by some form of normalization.

Fitting is just one approach to normalization. One could, for example, take the average or the median of the signal from all peptides that have the same composition and then divide all of those peptide measurements by that average or median. This would not involve fitting, but would be another form of normalizing the values to remove the part of the signal due to composition alone and leave signal that was due to the order of the amino acid.

Of course, the opposite could be done by the approaches above; one could remove the part of the signal due to order and only consider that part that is describable based on composition.

Those skilled in the art will realize that there are many different ways to characterize a chemical structure. For example, instead of considering the measurement as a function of the order and the composition, one might consider the measurement in terms of the part of the value that depends on the charge and the part that does not. Alternatively, hydrophobicity, length (number of amino acids in the case of a peptide), molecular weight, solubility, or calculated properties of the structure such as volume, flexibility, and many other chemical and structural properties of the molecules in the array or library could be used in a similar fashion. There is a substantial literature on the subject of chemical descriptors used for different kinds of molecular structures. For example, one list of descriptors used to describe peptides is given by Sanberg et al., 1998, J. Med. Chem. 41, 2481-2491. Some descriptors used in other small molecule libraries are discussed and reviewed by Gozalbes and Pineda-Lucena, Comb. Chem. High Throughput Screen, 2011, 14, 548-458. One descriptor could be used or combinations of descriptors could be used by, e.g., adding additional sum terms over various descriptors to equations (1) or (2). As noted above, one could selectively remove one part or another of the signal, as appropriate for the application.

Ovarian Cancer Example

A dataset involving Ovarian Cancer blood samples, 62 case and 94 control, was used in which each sample was exposed to an array of ˜130,000 peptides on a surface. The peptides were synthesized with 16 of the 20 natural amino acids and the sequences were chosen to cover combinatorial sequence space as evenly as possible. The IgG antibodies where detected by a specific secondary antibody labeled with a fluorophore and the fluorescence due to that fluorophore was measured with a commercial array reader.

The case and control sample sets were separately fit to a composition model. The model had the form:

$${F}_{i} = {\sum }_{I} {a}_{y} {C}_{i , j}$$

Here Fᵢ are the fluorescence values for each of the peptides in the array, C_{i,j} is the composition matrix. The value of C_{i,j} is an integer representing the number of amino acid j present in peptide i.

Different numbers of amino acids, starting at the N-terminus, were used in the determination of the composition of each peptide. If you use just one residue (the N-terminus) and model the binding with 16 coefficients (one for each aa) and then compare the model to the original data using a Pearson correlation, the correlation you get is 0.31. Thus, a small, but significant amount of the binding can be described by just knowing the N-terminal amino acid. Looking at the 2^{nd}, 3^{rd}, 4t^{h} and 5^{th} amino acid, the models each one alone generates give a correlation coefficient of ˜0.2. In this dataset, the identity of the N-terminus is most important, but individual amino acids at multiple positions are involved in determining the overall binding as well.

FIG. 1 shows what happens if one starts at the N-terminal amino acid and then use 1, 2, 3, 4 . . . 13 amino acids in your compositional modeling (here all amino acids up that that number starting at the N-terminus were used). As one increases the number of amino acids, the model becomes more accurate. Note that there are always just 16 free parameters in the fit (one for each type of amino acid), so the number of fitting parameters are constant. This fit is length by length: each length of peptide in the array (not all peptides in the array have the same length) is fit separately. By the time one has included the first 10 amino acids, the correlation has maxed at about 0.59.

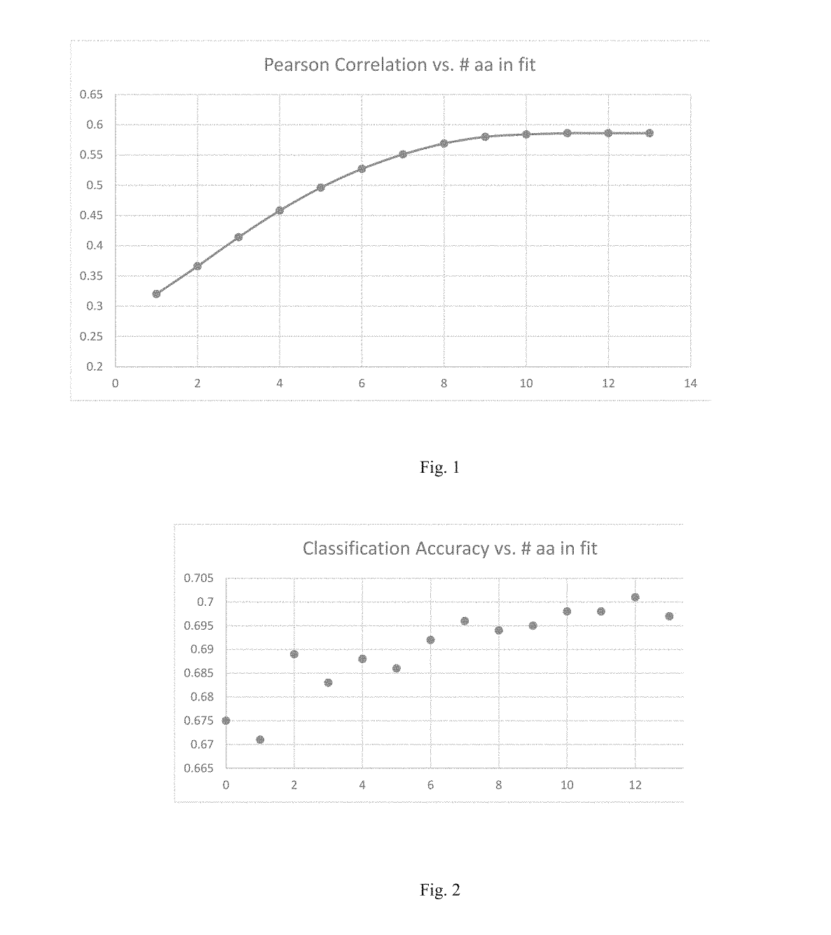

FIG. 2 shows what happens if one takes the original data and divide the actual value for binding to each peptide by the value resulting from the compositional fit and then perform a classification with the data to distinguish case (cancer) from control samples. This classification was done by first selecting those features that gave the greatest difference between case and control via a Ttest and then using those features, training a support vector machine classifier. 25% of the samples are left out of the training and used as the test case. This was done repetitively to obtain an average classification accuracy (4-fold cross validation). For the original unmodified data, the accuracy is about 0.68. A substantial amount of the binding variation in the data is removed by taking the ratio, and the classification improves as you perform the normalization. This suggests that removing the compositional part of the data improves performance. Note that the increase in accuracy more or less follows the Pearson correlation of the fit and the original data. The more of the compositional binding removed, the better it gets.

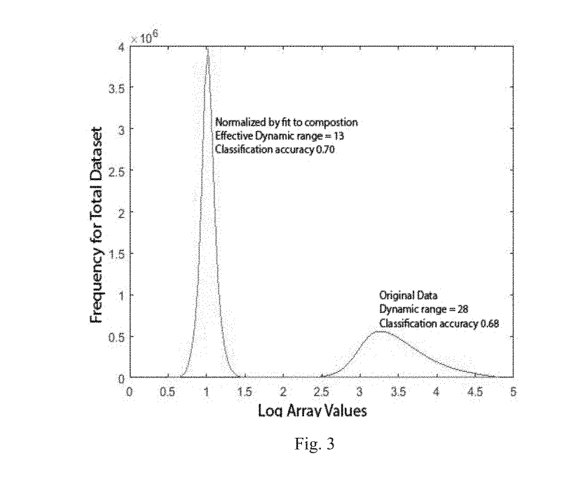

FIG. 3 shows the distribution (log intensity on the x-axis) of the data for the original dataset and the normalized set. The dynamic range of the normalized data decreases by a factor of ˜2, yet it classifies slightly better. Again, it appears that much of the binding (particularly strong binding) that is seen is compositional and not important in array performance.

The embodiments shown and described herein are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of analyzing data from an array or library comprising a set of chemical structures, the method comprising:
(a) obtaining a data set associated with said set of structures based on a signal derived from interaction of said set of structures with an added molecule or molecules of interest; and
(b) applying a model description to said data set that enables the removal at least a portion of the signal due to chemical composition rather than covalent structure.

2. The method of claim 1, further comprising the step of evaluating the effect of removing at least a portion of the signal on the ability to classify an interaction between said set of structures and a test sample.

3. The method of claim 1, wherein the model comprises
$${F}_{i} = {\sum }_{I} {a}_{y} {C}_{i , j} ,$$
wherein Fi is fluorescence from chemical structure i, aj is a coefficient determined in the fit for the j types of chemical structure subunits, and Ci,j is the composition in terms of the number of each of the j chemical structure subunits in chemical structure i.

4. The method of claim 1, wherein said molecule or molecules of interest comprise antibodies and said set of structures comprise peptides.

5. The method of claim 1, wherein said signal comprises imaging of said interaction between the set of structures and the added molecule or molecules of interest.

6. The method of claim 5, wherein said imaging is of a florescent marker associated with said molecule or molecules of interest.

7. The method of claim 1, wherein said applying is performed with a specially programmed digital processing device that includes one or more non-transitory computer readable storage media encoded with one or more programs that processes information about interaction of said set of structures with the added molecule or molecules of interest according to said model.

8. The method of claim 2, wherein said evaluating is performed with a specially programmed digital processing device that includes one or more non-transitory computer readable storage media encoded with one or more programs that processes information about removing at least a portion of the signal on the ability to classify an interaction between said set of structures and a test sample.

9. The method of claim 1, wherein the set of chemical structures comprise nucleic acids.

10. A method of analyzing data from a peptide array or library comprising a set of peptide structures, the method comprising:
(c) obtaining a data set associated with said set of peptide structures based on a signal derived from interaction of said set of peptide structures with an added molecule or molecules of interest; and
(d) applying a model description to said data set that enables the removal at least a portion of the signal due to amino acid composition rather than covalent structure.

11. The method of claim 10, further comprising the step of evaluating the effect of removing at least a portion of the signal on the ability to classify an interaction between said set of peptide structures and a test sample.

12. The method of claim 10, wherein the compositional model comprises
$${F}_{i} = {\sum }_{I} {a}_{y} {C}_{i , j} ,$$
wherein Fi is fluorescence from peptide i, aj is a coefficient determined in the fit for the j types of amino acids, and Ci,j is the composition in terms of the number of each of the j amino acids in peptide i.

13. The method of claim 10, wherein said molecule or molecules of interest comprise antibodies.

14. The method of claim 10, wherein said signal comprises imaging of said interaction between the set of peptide structures and the added molecule of interest.

15. The method of claim 10, wherein said imaging is of a florescent marker associated with said molecule of interest.

16. The method of claim 10, wherein said applying is performed with a specially programmed digital processing device that includes one or more non-transitory computer readable storage media encoded with one or more programs that processes information about interaction of said set of structures with the added molecule of interest according to said compositional model.

17. The method of claim 11, wherein said evaluating is performed with a specially programmed digital processing device that includes one or more non-transitory computer readable storage media encoded with one or more programs that processes information about removing at least a portion of the signal on the ability to classify an interaction between said set of peptide structures and a test sample
